(19) United States
(12) Patent Application Publication
(10) Pub. No.: US 2024/0033831 A1
(43) Pub. Date: Feb. 1, 2024

(54) Method for improved starting of drilling with a drilling device in an existing borehole, and drilling system

(71) Applicant: Hilti Aktiengesellschaft, Schaan (LI)

(72) Inventor: Tobias DREXL, Weil (DE)

(21) Appl. No.: 18/021,357

(22) PCT Filed: Aug. 3, 2021
(86) PCT No.: PCT/EP2021/071620

§ 371 Date: Feb. 14, 2023

(30) Foreign Application Priority Data
Aug. 17, 2020 (EP) 20191325.8

(51) Int. Cl. B23B 35/00

(52) U.S. Cl. CPC B23B 35/00

(57) ABSTRACT

A method for improved starting of drilling with a drilling device in an existing borehole. The drilling device comprises can be operated in a first operating state and in a second operating state, wherein a switchover between the operating states can take place depending on a comparison between friction data and depending on a direction of movement of the drilling device. In a second aspect, the invention relates to a drilling system which comprises a drilling device and an auto-feed device for producing a feed for the drilling device. The drilling system and preferably set up to implement the proposed starting of drilling method. It is furthermore configured in such a way that a switchover between the first operating state and the second operating state occurs as a result of a comparison between an actual value of a friction torque and a reference value in conjunction with determination of a direction of movement of the drilling device.

The present invention relates to a method for improved starting of drilling with a drilling device in an existing borehole.

### BACKGROUND

Power tools that are equipped with an auto-feed device and operate together therewith are known from the prior art. In the context of the invention, a system made up of a power tool and an auto-feed device is referred to preferably as a drilling system. An auto-feed device is preferably set up to bring about a forward movement of the power tool and to control such a forward movement. To this end, a feed produced by the auto-feed device can be transmitted to the power tool such that the power tool is driven further into the substrate to be worked.

For the control of the forward movement of the power tool into the substrate, control devices on the power tool and/or on the auto-feed device are used. These control devices of conventional drilling systems, as are known from the prior art, usually operate with a setpoint/actual-value comparison between a reference variable and a measured variable that actually exists, i.e. is able to be determined. The reference variable can be for example the torque of the motor of the power tool.

### SUMMARY OF THE INVENTION

In this case, it is possible for example for the situation to occur in which the measured value of the torque (“measured variable”) is higher than the reference value, i.e. the reference torque. If the control device of the drilling tool identifies such a situation, it usually causes the power tool or the tool of the power tool to be moved out of the borehole. This occurs in particular when the control device determines a speed of the feed motor that is negative with respect to the drilling direction. Such a situation frequently occurs when a drilling operation is intended to be started in a borehole; it is illustrated in FIG. 2.

The reference torque for the starting of drilling with a starting of drilling speed at the drilling motor, i.e. the reference value for the torque, can, however, also be lower than the friction torque during “normal” starting of drilling with a “normal” starting of drilling speed. In particular, the reference torque can turn out to be very much lower than the friction torque. This situation frequently occurs when a drill bit is placed on a surface to be worked in order to start a (new) drilling operation. In the context of the invention, this situation is referred to preferably as “normal starting of drilling” and is illustrated in FIG. 1. In this case, the friction torque is usually lower than the reference torque on account of the wall friction. The situation illustrated in FIG. 1 preferably corresponds, in the context of the invention, to the standard situation “starting of drilling on a surface”.

The size of the torques with respect to one another is indicated schematically in FIG. 1 by the size of the arrows. In other words, the size ratios of the arrows in FIG. 1 schematically indicate the size ratios of the torques.

In the application “starting of drilling on a surface”, good working results are generally achieved because the control device of the power tool is optimized for operation in this standard situation. In particular, in this working situation of the drilling system, concrete can be broken down by a corresponding downward pressure. According to the invention, the expression “downward pressure” means preferably that a feed in the direction of the borehole to be deepened is produced. In other words, it means preferably a movement or a feed in the direction of the deepest point of the borehole. This feed is produced preferably by the auto-feed device and transmitted to the power tool. According to the invention, the term “downward” corresponds to a positive direction of movement of the drilling device or of its tool, i.e. in particular of the drill bit.

FIG. 2 shows the second standard situation, for which conventional drilling systems can be optimized, namely “drilling in an existing borehole”. In this situation, the friction torque is usually higher than the reference torque on account of the wall friction. In FIG. 2, too, the size of the torques with respect to one another is indicated schematically by the size of the arrows. In this situation, it is harder for the control device to work, since the reference torque cannot be achieved by the measured variable. The control device usually reacts to this situation by relieving the load on the drilling system until a state as per FIG. 1 has been re-established. One possibility of producing a situation as per the standard situation “starting of drilling on a surface” consists, for the control device, in driving the drilling tool out of the borehole. It is not desired for the drilling device to be driven out of the borehole, however, since, as a result, the drilling operation is not advanced and concrete, rock or masonry is not broken down.

In reality, however, it is often the case that drilling in a pre-existing borehole is intended to be started or continued. In this case, the wall friction of the tool of the power tool increases significantly in relation to the borehole wall. The friction that arises between the drill bit and borehole wall when starting to drill in existing boreholes is much higher than when starting to drill with the power tool on a surface. This drilling situation, which occurs frequently, can often be satisfied only poorly with conventional drilling systems, which are optimized for use in the standard situation “starting of drilling on a surface”. In particular, the parameters for the starting of drilling, which are stored in the power tool for the standard situation, are not suitable for drilling in an existing borehole. This can have the result, for example, that the friction torque in the borehole is too high for the starting of drilling stage. As a result, the motor of the power tool can “tip”, and this can result in the power tool jamming in the borehole. In particular, as a result, the situation can arise that no torque is converted when breaking down concrete. In the case of conventionally operating drilling systems, the described situation usually has the result that, on account of the calculation of the setpoint/actual-value comparison, the drilling device or the drilling system is moved out of or extracted from the borehole. However, many users of the power tool find such extraction to be unsatisfactory.

It is an object of the present invention to overcome the above-described drawbacks and defects of the prior art and to specify an improved control for a drilling system, with which optimum drilling results can be achieved not only in a standard situation but in particular also when a drilling operation is intended to be started in an existing borehole. In particular, a control method for a drilling system is intended to be provided, with which the start of a drilling operation in an existing borehole is intended to be improved. Furthermore, a drilling system comprising a drilling device and an auto-feed device is intended to be provided, with which the improved control method can be implemented.

The present invention provides a method for improved starting of drilling with a drilling device in an existing borehole, wherein the drilling device comprises an auto-feed device for producing a feed for the drilling device, and wherein the drilling device can be operated in a first operating state and in a second operating state. The method is characterized by the following method steps:
a) providing the drilling device, wherein a reference value for a torque during operation of the drilling device in the first operating state is stored in the drilling device,
b) operating the drilling device in the first operating state,
c) determining an actual value for the friction of the drill bit of the drilling device in the existing borehole,
d) comparing the actual value with the reference value,
e) determining a direction of movement of the drilling device in the existing borehole, wherein the direction of movement of the drilling device is predefined by the auto-feed device, and
f) terminating the first operating state when the actual value is higher than the reference value and when the direction of movement of the drilling device is negative.

According to the invention, it is preferred for the first operating state, which is preferably also referred to as the starting of drilling stage, to correspond to the situation as per FIG. 2. The operating state of the drilling device is illustrated in the figures preferably by the large number in the drill bit. FIG. 2 illustrates preferably the particular situation in which the drilling operation in an existing borehole is being started. According to the invention, it is preferred that the wording “start of a drilling operation” and the expression “starting of drilling” are used synonymously in the context of the present invention. Preferably, the proposed starting of drilling method can also be referred to as a “method for controlling a drilling operation in an existing borehole”. Preferably, the second operating state corresponds to the situation that is illustrated in FIG. 1, the “starting of drilling on a surface”. In other words, it is preferred according to the invention that the first operating state corresponds to a starting of drilling phase or starting of drilling stage of the drilling device and the second operating state corresponds to a drilling phase of the drilling device.

According to the invention, it is preferred that the expression “reference value for the torque” means the reference value for the torque at the drill bit of the drilling device. The reference value for the torque is preferably also referred to as reference torque according to the invention. In other words, according to method step a), a drilling tool is provided in which a reference value for a torque at the drill bit of the drilling device is stored, with the result that the reference torque for the proposed method is provided. This reference torque can, according to a subsequent method step, be compared with an actual value of the friction of the drill bit. This actual value of the friction of the drill bit is preferably referred to as “friction torque” or “actual torque” according to the invention. According to the invention, it is preferred that the friction torque is determined, as friction of the drill bit of the drilling device, as a measured variable in the existing borehole.

In the context of the present invention, it is possible to provide in the drilling motor a measuring device with which preferably the current that flows through the motor is measured. This measuring device can be configured for example as a shunt. The current that is measured by the measuring device is preferably proportional to the current torque. If, during the measurement, it is established that, in spite of load relief, the actual torque does not drop, it can be concluded that this is a friction torque.

In a later method step, it is preferred that a direction of movement of the drilling device in the existing borehole is determined. To this end, it is possible to use for example the Hall signals of the motor. In particular, it is possible to use the Hall signals of the motor in the feed device to determine the direction of rotation. To this end, an incremental encoder can additionally be used. If, for example, an increment is measured, this can be interpreted as meaning that the drilling device is being moved into the borehole, while a decrement can mean that the drilling device is being moved out of the borehole.

Preferably, the direction of movement is determined with regard to its direction and/or with regard to its value or absolute value. In other words, a specific spatial direction in which the drilling device is being moved is determined, and the speed at which the drilling device is being moved in the existing borehole. Preferably, the movement of the borehole is restricted to two spatial directions. The drilling device can move in particular in the “upward” spatial direction or in the “downward” spatial direction in the existing borehole. According to the invention, these movements are referred to as negative (“upward” spatial direction) and positive (“downward” spatial direction) direction of movement, respectively. The movement of the drilling device is preferably controlled or brought about by the auto-feed device of the drilling system. According to the invention, it is preferred that both the power tool and the auto-feed device each have a motor, wherein the motor of the power tool is preferably also referred to as “drilling motor” according to the invention, while the motor of the auto-feed device is preferably also referred to as “feed motor”. The movement of the drilling device is controlled by the auto-feed device for example in that a feed that is produced by the feed motor is transmitted to the drilling device and/or its tool.

The above-described method steps take place in particular in the first operating state of the drilling device, i.e., according to the invention, preferably when drilling in an existing borehole or when a drilling operation in an existing borehole is intended to be started. Provision is made according to the invention that the first operating state is terminated when the actual value of the friction of the drill bit is higher than the reference value of the torque and when the direction of movement of the drilling device is negative, i.e. when the auto-feed device causes the drilling device to move upward in the existing borehole.

According to the invention, it may be preferred for drilling to take place in a floor. In this case, the wording “upward spatial direction” or “downward spatial direction” is suitable for describing the drilling and the starting of drilling operations. In particular, a negative direction of movement of the drilling device is defined in that the drilling device is extracted from the borehole, i.e. in that a distance between the bottom or the substrate of the borehole and the drilling device becomes greater. According to the invention, it is preferred that the expressions “bottom of the borehole” and “substrate of the borehole” correspond to the deepest point within the borehole. However, it may also be preferred according to the invention for drilling to take place for example into a substrate, wherein the substrate is a wall. Drilling progress then takes place preferably into a depth of the wall. In this application, the wording “downward spatial direction” means that drilling is taking place into the wall, in particular with the aim of deepening the borehole. The wording “upward spatial direction” means in this application that the drilling device is being moved out of the borehole, wherein the movements of the drilling device in the borehole take place substantially parallel to a ground surface in this application, or substantially parallel to the substrate on which the wall which is being drilled into is standing.

According to the invention, it is preferred that, during the first operating state, which is preferably also referred to as the starting of drilling stage, in particular a comparison between the actual value and reference value, or friction torque and reference torque, takes place. The comparison of the actual value with the reference value advantageously allows closed-loop control or setting of the torque with which the drill bit is operating and which is transmitted to the drill bit.

The basic idea on which the invention is based is that the comparison of the actual and reference values is linked to the movement or the direction of movement of the drilling device. In particular, it is preferred according to the invention that the comparison of the actual and reference values takes place in conjunction with the determining of the movement or the direction of movement of the drilling device. During normal drilling operation, which is referred to preferably as the second operating state according to the invention, the drilling device moves in a direction of movement which is defined preferably as the “positive direction of movement” in the context of the present invention. This movement is preferably the movement of the drilling device into the borehole, i.e. in the direction of a bottom or substrate of the borehole.

In particular, as a result of the comparison of friction torque and reference torque in conjunction with the determination of the direction of movement of the drilling device in the borehole, improved control of the starting of drilling operation in an existing borehole is allowed. According to the invention, it is very particularly preferred that, as a result of the comparison of friction torque and reference torque, closed-loop control of the torque of the drill bit or of the drilling device is provided. This closed-loop control can also be switched off for example, in particular when the first operating state has been terminated as per method step f) of the proposed method. In this case, it is assumed that the starting of drilling is taking place in an existing borehole, and so it is not necessary to carry out a conventional starting of drilling stage that does not start in an existing borehole. In particular, the comparison, provided according to the invention, of the actual value and reference value in conjunction with consideration of the direction of movement of the drilling device makes it possible for the drilling device to be able to identify, preferably automatically, whether the drilling operation is starting in an existing borehole or on a preferably planar substrate.

The drilling device may be in particular a diamond power tool, in particular a core drilling device, which is set up to produce cylindrical drill cores and to cut them out of a substrate to be worked. The tool of such a power tool with which the drill core is produced is preferably referred to in the context of the invention as a drill bit. In other words, it is preferred in the context of the invention that the drilling device comprises a drill bit as a tool.

According to the invention, it is preferred that the proposed method can comprise the additional method step that, after the first operating state has been terminated, the drilling device is driven deeper into the borehole. A movement of the drilling device “deeper into the borehole” preferably corresponds, according to the invention, to a movement in a positive direction of movement. According to the invention, a movement of the drilling device in a positive direction of movement is preferably also referred to as “driving the drilling device” further or deeper into the borehole. Preferably, extraction of the drilling device from the borehole corresponds to a movement in a negative direction of movement. This movement of the drilling device into the borehole is brought about and controlled preferably by the auto-feed device.

It may be preferred according to the invention that the drilling device is driven into the borehole with a constant speed of a motor of the auto-feed device. A significant advantage of the invention is that the device is driven into the borehole with a relatively slow, i.e. low speed of the feed motor, wherein, when the torque is increased, a smooth transition into feed operation under closed-loop control is allowed.

According to the invention, it is preferred that the actual value and reference value are compared with one another in a further comparison, wherein the drilling operation is continued in the second operating state when a predefined ratio of actual value to reference value is ascertained in the further comparison. It is then assumed that the drill bit has reached the substrate that is actually to be worked, and so the drilling operation can be continued in the normal drilling stage. Preferably, in this comparison, the reference value for the torque is compared with the actual value of the friction of the drill bit, the friction torque. According to the invention, it is preferred that the comparisons between the actual value and reference value take place continuously. However, it may also be preferred that the comparisons take place individually, for example with fixed time intervals or in a manner triggered by various events that may arise during a drilling operation. The same goes, mutatis mutandis, for the determination of the direction of movement of the drilling device.

According to the invention, it is preferred that the ratio between the actual value and reference value, at which the normal drilling operation is continued, is in a region of about 50%. However, many other values are also possible, for example 40% or 60% or 42% or 55%. Preferably, given a ratio of 50% between the actual value and reference value, the actual value is half the size of the reference value.

According to the invention, it is preferred that the system made up of the drilling device and auto-feed device is controlled with a fixed speed of the motor of the auto-feed device after the first operating state has been terminated. This feed motor speed can be for example 150 rounds per minute (rpm). However, it may also be preferred according to the invention that the drilling feed is controlled with a fixed feed rate after the first operating state has been terminated. This feed rate is preferably brought about by the auto-feed device and transmitted to the drilling device. The direction of this feed direction in which the drilling device is moved into the borehole corresponds preferably to a positive direction of movement, i.e. a movement into the borehole. If the actual torque lies for example in a region of 50% of the reference value, it is assumed that the tool of the drilling device has arrived at the substrate to be worked at the bottom or deepest point of the borehole. There, the drilling operation can be continued preferably in the second operating state of the drilling device.

The described procedure is associated with the advantage that, as a result, too rapid advancing as far as the substrate to be worked is avoided. Too rapid advancing as far as the bottom of the existing borehole is undesired because it is possible for the drill bit and/or the drilling device to be damaged as a result. In conventionally operating drilling devices, too rapid advancing of the drill bit as far as the substrate can be caused in particular by a jump in the reference torque. Such “jumps” in the reference torque are avoided effectively by the present invention. In particular, improved starting of drilling with a drilling device in existing boreholes is achieved by the invention. In particular, undesired driving of the drilling device out of the borehole by the auto-feed device is effectively avoided with the method. Furthermore, tests have shown that a drilling operation that proceeds more smoothly and with less vibration can be allowed with the invention.

According to the invention, it is preferred that the first operating state is terminated when the actual value is higher than the reference value for a predefined time period t. This predefined time period t can be for example 5 s. However, it can also be longer or shorter than 5 s, for example 1 s, 10 s, 3 s, 7 s or 12 s, 15 s, 18 s, 20 s, 25 s or 30 s.

In a further aspect, the invention relates to a drilling system, wherein the drilling system comprises a drilling device and an auto-feed device for producing a feed for the drilling device, wherein the drilling device is able to be operated in a first operating state and in a second operating state. The drilling system is characterized in that the system is configured in such a way that a changeover between the first operating state and the second operating state occurs as a result of a comparison between an actual value of a friction torque and a reference value in conjunction with determination of a direction of movement of the drilling device. The definitions, technical effects and advantages that have been described for the proposed method apply analogously to the drilling system, and vice versa.

According to the invention, it is preferred that the first operating state is terminated when the actual value is higher than the reference value and when the direction of movement of the drilling device is negative.

The invention can be clarified using the following exemplary embodiment: In the context of the invention, a comparison between an actual torque and a reference torque is provided, wherein the reference torque corresponds preferably to a reference value for the torque and the actual torque corresponds to the actual value of the friction of the drill bit. If, during the starting of drilling, the actual torque is higher than the reference torque for a certain time (for example 5 s), and when the feed motor travels out of the borehole, the starting of drilling stage can be automatically terminated and the normal drilling speed of the drilling motor can be selected. In addition, the closed-loop control can be switched off. It is assumed that it is a matter of starting to drill in a pre-existing borehole.

For example, it is then possible to wait until the drilling motor has arrived at a nominal speed and the second operating state has been achieved, which corresponds preferably to the standard application “starting of drilling on a surface”. This standard application is illustrated schematically in FIG. 1.

Subsequently, the drilling system can be controlled with a fixed feed motor speed. For example, a speed of the feed motor of 150 rpm or a feed rate of 0.1 mm/min can be set. The movement of the drilling device takes place in this case preferably in the “downward” spatial direction. If the actual torque has reached for example 50% of the torque, it is assumed that the drill bit has arrived at the actual substrate again and drilling can be continued.

This prevents too rapid advancing as far as the substrate. Such too rapid advancing as far as the substrate can result undesirably from the sudden jump in the reference torque in conventionally operating drilling systems. In this case, jumps in the reference torque from 0.8 Nm to 2.2 Nm occur for example.

If the drill bit sticks in spite of the implementation of the proposed method, 50% of the reference torque is reached for example, and the closed-loop control of the drilling system is switched on again, such that the system can continue to operate as per a normal drilling operation.

Further advantages of the invention will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a schematic illustration of a starting of drilling operation on a substrate (second operating state)—prior art

FIG. 2 shows a schematic illustration of a starting of drilling operation in an existing borehole (first operating state)—prior art

FIGS. 3a, 3b, 3c and 3d show schematic illustrations of a drilling operation in an existing borehole according to one possible configuration of the proposed method

### DETAILED DESCRIPTION

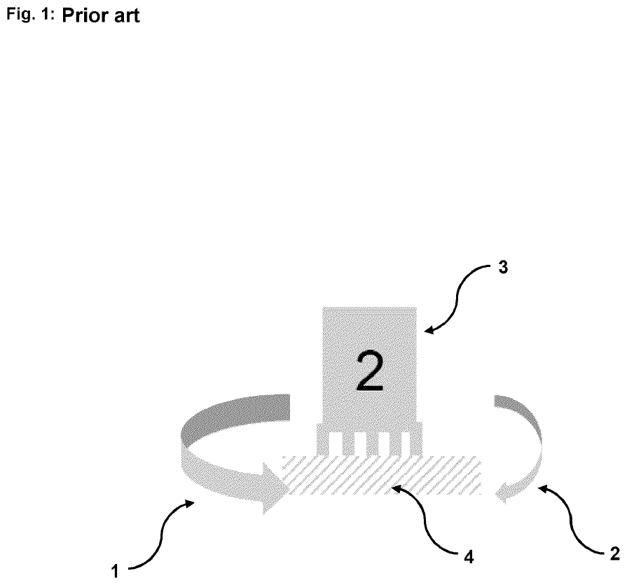

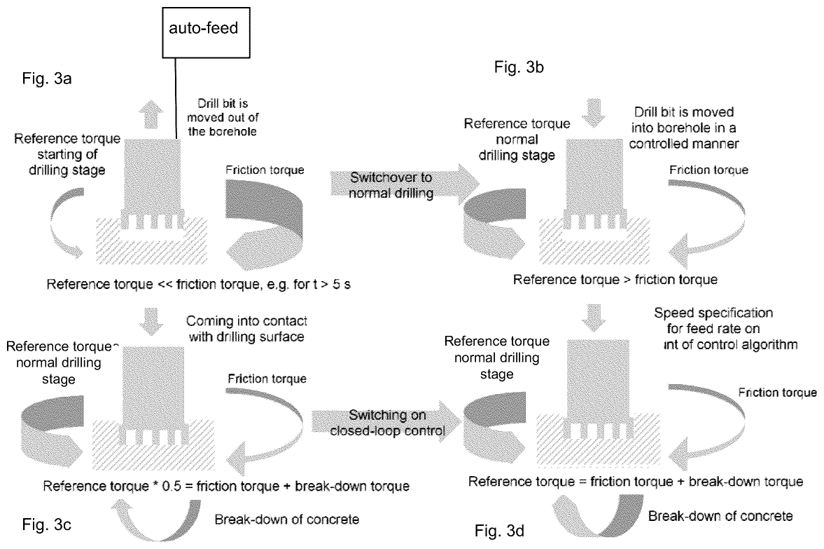

FIG. 1 shows a schematic illustration of a starting of drilling operation on a substrate (4), as is known from the prior art. According to the invention, this situation is preferably also referred to as the second operating state of the drilling device (3). Illustrated is a drill bit as a constituent part of the drilling device (3), which is positioned on a substantially planar or level substrate (4). If, in this state, a drilling operation with the drilling device (3) is intended to be started, the reference torque (1) is usually greater than a friction torque (2), wherein the friction torque (2) is measured as a measured variable preferably during operation of the drilling device (3). The size of the torques (1, 2) with respect to one another is indicated schematically in the figures by the size of the arrows. In other words, the size ratios of the arrows in the figures schematically indicate the size ratios between the reference torque (1) and friction torque (2). The reference value (1) for the friction is stored preferably in a control device of the drilling device (3). The reference value (1) can also be stored in a control device of an auto-feed device (net illustrated solely schematically in FIG. 3) of the drilling device (3). The auto-feed device is preferably set up to bring about a forward movement of the drilling device (3) or to produce a feed that can be transmitted to the drilling device (3). Since the actual value (2) of the friction is lower than the reference value (1), in these cases open-loop or closed-loop control of the movement of the drilling device (3) is easily possible and is also readily managed by conventionally operating drilling systems.

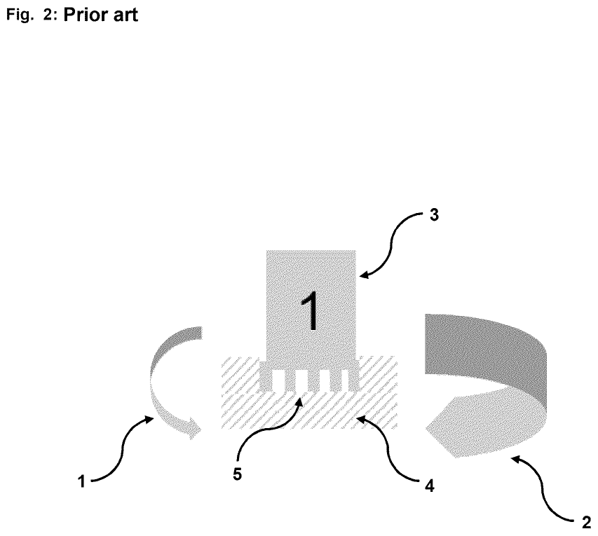

The open-loop or closed-loop control of the movement of the drilling device (3) is harder in the applications that are illustrated by way of example and schematically in FIG. 2. In the situation illustrated in FIG. 2, a drilling operation in an existing borehole (5) is intended to be started, as is known from the prior art. This means that the drill bit of the drilling device (3) is already located in the existing borehole (5) at the start of the drilling operation. In the working situation, illustrated in FIG. 2, of the drilling device (3), the reference torque (1) is lower than the friction torque (2). The high friction torque (2) is in particular attributable to the wall friction present in the existing borehole (5), i.e. to the resistance that the drill bit has to overcome during its rotational movement within the borehole (5) in order to break down concrete or to cut the concrete core out of the substrate (4). As a result of the proposed method, the starting of drilling in an existing borehole (5) is much easier.

A possible configuration of the proposed method and of the invention is illustrated schematically in FIG. 3. In particular, FIG. 3 shows a possible sequence of a drilling operation in an existing borehole (5).

FIG. 3 is made up of four individual working situations, which, starting from subfigure a) at the top left of the image, are designated a) to d). Illustrated at the middle of the subfigures in each case is the drill bit of a drilling device (3), which is intended to continue a drilling operation in an existing borehole (5). In subfigure a), the reference torque (1) that is illustrated in each case on the left-hand side of the drill bit in the subfigures, is much lower than the friction torque (2) or the measured actual value (2) for the friction of the drill bit in the borehole (5). This state can, according to the example illustrated in FIG. 3a), last longer than a time period t of 5 s. In this situation, in the case of a conventionally operating drilling system made up of a drilling device (3) and an auto-feed device (illustrated solely schematically in FIG. 3), the auto-feed device will frequently ensure that the drill bit is moved out of the borehole on account of the high wall friction within the borehole (5). This movement of the drill bit is illustrated by the upward arrow in subfigure 3a). The situation illustrated in subfigure 3a) can also be referred to as the starting of drilling stage.

The drilling system can then switch over to normal drilling operation, wherein normal drilling operation can proceed for example in the same way as when drilling on a substantially planar or level substrate (4). After the switchover to normal drilling, a drilling situation as per subfigure 3b) can exist (see FIG. 3, top right). In this “normal drilling stage”, a friction torque (2) is determined as measured variable, which is much lower than the reference value (1) stored in the drilling system. In other words, the reference torque (1) is higher than the friction torque (2). In reaction to the measured actual friction values (2), the drill bit of the drilling device (3) can be driven into the borehole (5). This movement of the drilling device (3) is preferably brought about or controlled by the auto-feed device of the drilling device (3).

In subfigure 3c), the drill bit of the drilling device (3) coming into contact with a drilling surface, i.e. the substrate (4) to be worked, is illustrated. In particular, subfigure 3c) also shows a working situation in a normal drilling stage of the drilling system. In the example illustrated in subfigure 3c), the reference torque (1) is higher than the friction torque (2), which corresponds preferably to the actually measured actual value (2) of the friction. In particular, the friction torque (2), together with a break-down torque (without a reference sign), can correspond to half of the reference torque (1). In this situation, breaking down concrete and thus working progress is advantageously possible.

A transition to a situation as per subfigure 3d) is allowed by switching on the closed-loop control. In the working situation illustrated in subfigure 3d), too, the drilling system is in a normal drilling stage. In the working situation depicted in subfigure 3d), the reference torque (1) is higher than the friction torque (2). In particular, the reference value (1) can correspond in this situation to the sum of the friction torque (2) and the break-down torque. In this situation, too, working progress can be achieved by breaking down concrete. The switched-on closed-loop control ensures, by applying a control algorithm, that the drilling system obtains a specification for the speed of the feed rate. In other words, the drilling system can obtain a speed specification for the speed of the feed motor of the auto-feed device.

### LIST OF REFERENCE SIGNS

1 Reference torque
2 Friction torque
3 Drilling device, or drill bit of the drilling device
4 Substrate
5 Existing borehole
BK Drill bit

1-8. (canceled)

9: A method for improved starting of drilling with a drill in an existing borehole, the drill having an auto-feed, and the drill operable in a first operating state and in a second operating state, the method comprising:
a) providing the drill, wherein a reference value for a torque during operation of the drill in the first operating state is stored in the drill,
b) operating the drilling device in the first operating state,
c) determining an actual value for the friction of the drill bit of the drill in the existing borehole,
d) comparing the actual value with the reference value,
e) determining a direction of movement of the drill in the existing borehole, wherein the direction of movement of the drill is predefined by the auto-feed device,
f) terminating the first operating state when the actual value is higher than the reference value and when the direction of movement of the drill is negative.

10: The method as recited in claim 9 wherein after the first operating state has been terminated, the drill is driven deeper into the borehole.

11: The method as recited in claim 10 wherein the drill is driven into the borehole with a constant speed of a motor of the auto-feed device.

12: The method as recited in claim 10 wherein the drill is driven into the borehole with a constant feed rate.

13: The method as recited in claim 10 wherein the actual value and reference value are compared with one another in a further comparison, wherein, at a predefined ratio of actual value to reference value, the drilling operation is continued in the second operating state.

14: The method as recited in claim 9 wherein the first operating state is terminated when the actual value is higher than the reference value for a predefined time period.

15: A drilling system comprising a drill and an auto-feed for feeding the drill, wherein the drill is operable in a first operating state and in a second operating state, the system being configured in such a way that a changeover between the first operating state and the second operating state occurs as a result of a comparison between an actual value of a friction torque and a reference value in conjunction with determination of a direction of movement of the drilling device.

16: The drilling system as claimed in claim 15 wherein the first operating state is terminated when the actual value is higher than the reference value and when the direction of movement of the drilling device is negative.
